(19) United States
(12) Patent Application Publication
(10) Pub. No.: US 2010/0266652 A1
(43) Pub. Date: Oct. 21, 2010

(54) SLOW RELEASE BIOCIDAL THERMOPLASTIC COMPOSITIONS AND ARTICLES

(76) Inventors: H. HARALD LUTZMANN, CLEVELAND HTS., OH (US); JOHN T. INGLIS, VERO BEACH, FL (US)

Correspondence Address: D.A. Stauffer Patent Services LLC, 1006 Montford Rd., Cleveland Hts., OH, 44121-2016, US

(21) Appl. No.: 12/824,061

(22) Filed: Jun. 25, 2010

Related U.S. Application Data
(63) Continuation-in-part of application No. 11/766,076, filed on Jun. 20, 2007, now abandoned.
(60) Provisional application No. 60/805,374, filed on Jun. 21, 2006.

(51) Int. Cl. A01N 25/34; A01N 59/00; A01P 1/00

(52) U.S. Cl. 424/402; 424/661

(57) ABSTRACT

In one aspect, the invention is directed to a biocidal composition, comprising a mixture of a substantially oxidation-resistant thermoplastic polymer having a melting point of about 60° C. to about 100° C.; and a composition for releasing chlorine dioxide gas upon exposure to moisture and having a bulk density less than about 0.15 g/cc, wherein the mixture of the first thermoplastic polymer and the gas releasing composition has a higher bulk density than gas releasing composition and is a substantially free-flowing non-dusting powder. In another aspect, the invention provides a polymeric matrix comprising the biocidal composition and a second thermoplastic polymer. Both the biocidal composition and the biocidal composition in the polymeric matrix are suitable for commercial manufacture of extruded, injection molded or blow molded articles, films, sheets, and the like.

### CROSS-REFERENCE TO RELATED APPLICATIONS

This application claims the benefit of U.S. Provisional Patent Application Ser. No. 60/805,374, filed Jun. 21, 2006, and is a continuation-in-part of U.S. patent application Ser. No. 11/766,076, filed Jun. 20, 2007.

### BACKGROUND OF THE INVENTION

The antiseptic, bactericidal, fungicidal and viricidal properties of chlorine dioxide (ClO₂) and methods of generating and releasing this strong oxidizing gaseous chemical have been described in the technical and patent literature. For example, the controlled release of biocidal and/or deodorant amounts of chlorine dioxide gas from the reaction of a metal chlorite and an acidified material that reacts with the metal chlorite in the presence of water vapor, but not in the substantial absence of liquid water or water vapor, is known.

In particular, Perlox™ is an available commercial product that allows slow and extended release of ClO₂ from an acidified expanded amorphous aluminum silicate (perlite) impregnated with a chlorite salt, when exposed to moisture. Crude (unexpanded) perlite is an amorphous volcanic glass having a specific gravity of 2.2-2.4 (or a bulk density of about 1.1 g/cc, grams per cubic centimeter) that has a relatively high water content until heated to temperatures of about 850-900° C. Upon heating, the crude perlite softens and water trapped in the structure of the material vaporizes and escapes, causing the expansion of the material to about 7 to 16 times its original volume. The expanded amorphous perlite is a fluffy white particulate typically having a specific gravity of 0.05-0.3, or a bulk density of about 0.03 g/cc to about 0.15 g/cc. In contrast, another available commercial product, Aseptrol™, is based on such dry hydrophilic materials such as synthetic or natural zeolites, hydrous or calcined clays, or the like, and has a specific gravity of about 1.5. That is, the specific gravity of the Perlox™-type materials is about 5 to 30 times less than that of the Aseptrol™-type materials.

Acidified expanded amorphous silicate products impregnated with a chlorite salt, like Perlox™, typically have such a low packing density such that they are dusting rather than free-flowing powders. Generally, they are commercially available in sealed packaging such as, but not limited to, pouches and the like, that protect them from ambient moisture until exposure to moisture for release of the ClO₂ is desired. However, because of the low bulk density and dusting properties of these materials, they can not readily be packaged by commercially available packaging machinery. Moreover, the explosive nature of ClO₂ in high concentrations and in contact with easily oxidized polymers at high temperatures, limits the use of the above-referenced products in extruded, injection-molded or blow-molded products.

### SUMMARY OF THE INVENTION

It was unexpectedly discovered that very low bulk density (less than about 0.15 g/cc, typically about 0.03 g/cc to about 0.15 g/cc) ClO₂-releasing biocidal compositions including, but not limited to, commercially available acidified expanded amorphous aluminum silicate products impregnated with a chlorite salt, can be packaged by commercially available packaging machinery provided that they are first incorporated into a low melting point, substantially oxidation-resistant thermoplastic polymer to form a mixture that is a relatively non-dusting and free-flowing powder having a higher bulk density than the starting biocidal composition. The resulting mixture then can be incorporated into a second thermoplastic polymer to form a polymer matrix from which extruded, injection molded or blow molded articles, films, sheets, combinations of these, and the like, can be manufactured. A release of ClO₂ from the polymer matrix is then proportional to the ingress of moisture into the matrix as a function of the prevailing ambient relative humidity. Moreover, the use of low melting point, substantially oxidation-resistant thermoplastic polymers allows the production of without danger of explosion associated with ClO₂.

Thus, in one aspect, the invention is directed to a biocidal composition, comprising a mixture of (a) a substantially oxidation-resistant first thermoplastic polymer having a melting point of less than about 100° C.; and (b) a composition for releasing chlorine dioxide gas upon exposure to moisture and having a bulk density less than about 0.15 g/cc, wherein the mixture of the first thermoplastic polymer (a) and the composition (b) has a higher bulk density than composition (b) and is a substantially free-flowing non-dusting powder. The first thermoplastic polymer has a moisture vapor transmission capability of about 100 to about 1000 grams per 24 hours per square meter per mil of thickness.

In another aspect, the invention provides a polymeric matrix comprising the biocidal composition and a second thermoplastic polymer in which the biocidal composition is embedded. Typically, the second thermoplastic polymer has a different, usually a lower moisture vapor transmission capability than that of the first thermoplastic polymer.

The invention further provides an extruded, injection molded or blow molded article, a film, a sheet, combinations of these, and the like.

### DETAILED DESCRIPTION OF THE INVENTION

According to aspects of the invention, a biocide having a bulk density less than about 0.15 g/cc, typically about 0.03 g/cc to about 0.15 g/cc, and that releases ClO₂ in proportion to water or moisture ingress, is mixed with a substantially oxidation-resistant first thermoplastic polymer, having a melting point of less than about 100° C., in order to increase the bulk density of the biocide. The resulting biocidal composition, containing both the first thermoplastic polymer and the biocide, has a substantially higher bulk density than original biocide and the mixture is a substantially free-flowing non-dusting powder, thus providing for greater ease of handling and packaging with commercially available packaging machinery.

The biocidal composition can also be embedded into a second thermoplastic polymer to form a polymeric matrix in order to further control the rate of moisture/water ingress and the rate of release of the ClO₂. Moreover, such a polymeric matrix can be formed by methods well known in the art of plastic manufacture into an extruded, injection molded or blow molded article, a film, a sheet, combinations of these, and the like. Articles such as these can also be very useful as, for example but not limited to, self-sterilizing agents during the time period in which the ClO₂ is continuously released. Non limited uses can include articles used to prevent infections, particularly hospital acquired infections, although their use is not limited to the hospital environment. Exemplary ClO₂ releasing articles can include, but are not limited to, injection molded or extruded body implants (knee or hip replacement parts, and the like), sutures, surgical drapes (extruded sheets), disposable gowns, disposable bedding, film and the like. Such articles can be packaged to prevent ClO₂ release until desired.

Suitable biocides for use in the invention are those that release ClO₂ gas upon exposure to moisture and have a bulk density less than about 0.15 g/cc, suitably about 0.03 g/cc to about 0.15 g/cc. These biocides are typically dusting, rather than free-flowing powders. An example of such a biocide that is a commercially available, is an acidified expanded amorphous aluminum silicate impregnated with a chlorite salt, Perlox™, manufactured by Bio-Cide International, and having a bulk density of about 0.093 grams/cc. However, other biocides having a low bulk density that fall within the above range are also useful in the invention.

The first thermoplastic polymer according to the invention has a low melting point, especially having a melting point of less than about 100° C., more especially about 60° C. to about 100° C., such that, when heated, the polymer can incorporate the ClO₂ source without degrading it. The suitable first thermoplastic polymers are also selected to have a substantial resistance to oxidation. In view of the explosive character of ClO₂ in high concentrations and in contact with easily oxidized polymers at high temperatures, it was found that low melting point polymers with good oxidation stability are the most suitable for safely incorporation of chlorine dioxide releasing compositions. A non-limiting example of a suitable first polymer is a polycaprolactone, such as those obtained from Dow Chemical as TONE P767 or P787, or a low molecular weight polyethylene such as Polywax®500 available from Baker Petrolite Polymers Div. of Baker Hughes, and mixtures thereof. However, many other such polymers are available and are well known to those of ordinary skill in the polymer arts.

Control of water vapor transmission and biocide release rates from the polymeric matrix, especially for preparation of extruded and shaped articles, can be achieved by the selection of combinations of thermoplastic polymers used for the polymer matrix. In particular, the first thermoplastic polymer in the biocidal composition has a moisture vapor transmission capability of about 100 to about 1000 grams per 24 hours per square meter per mil of thickness. However, the polymeric matrix formed by embedding the biocidal composition in the second thermoplastic polymer can have a moisture vapor transmission capability of about 10 to about 1000 grams per 24 hours per square meter per mil of thickness, different than that of the original biocidal composition and, typically, is a lower transmission rate.

As a non-limiting example, slowing of water vapor transmission and biocide release rate can be provided by blending a polyolefin (i.e., a polyethylene, polypropylene and/or polystyrene) (the second polymer) with the mixture of a polycaprolactone and biocide. Exemplary of suitable polyolefins include, but are not limited to, a low molecular weight (waxy) polyethylene (such as Polywax®500), a high molecular weight high density polyethylene (such as Microthene F from Eastman Chemicals), and the like. Other examples of suitable polyolefin compounds are also readily available and known. The relative amounts of the polymers can be varied according to the properties of each in order to achieve the desired rate of moisture transmission without undue experimentation.

In addition to the polymeric matrix formed by mixing the biocide composition with the second polymer and subsequent extruding, molding, sheeting, forming films, and the like, to manufacture various articles, the biocide compositions according to aspects of the invention can be employed as free-flowing powders or can, themselves, be formed into molded or extruded articles, films, sheets and the like. Because of the substantial increase in bulk density provided to the biocide by the first polymer, the biocidal compositions can be packaged by commercially available packaging machinery. Packaging protects and seals the product from moisture, especially ambient relative humidity, until release of the ClO₂ is desired.

In some aspects, the powder form of the invention compositions may be used, for example, in a pouch such as that described in U.S. Pat. No. 6,554,887. In another aspect, the powder can be safely extruded at temperatures below 100° C. into a film that can be used as it is for sterile packaging. In yet another aspect, one side of the biocide film can be adhered, such as by lamination or adhesive, to a second film having a low moisture vapor transmission, and the other side of the biocide film can be adhesively mounted to a non-woven or woven fabric. As a non-limiting example, such a biocide film can comprise a surface of a hospital gown or bed sheeting for use in hospital beds. The biocide compositions in powder form can also be formed into various other articles to be used as biocides, by injection molding, blow molding, or extrusion into a sheet for subsequent thermoforming. However, it is important that all processes of making or using the biocidal compositions and of forming articles from them be conducted at less than 35% relative humidity, preferably at less than 25% relative humidity, to avoid egress of ClO₂.

### EXAMPLES

The following examples illustrate methods of preparation of representative invention biocide compositions containing commercially available ClO₂ sources that are embedded in thermoplastic polymer matrices. The examples illustrate the preparation of free-flowing powders non-dusting powders and the release of ClO₂ therefrom upon exposure to moisture. The examples also illustrate the preparation of film from the powders and the subsequent release of the biocide from the film. The examples further illustrate the use of polyethylene waxes to lower moisture vapor transmission and slow the release rate of the biocide from both powders and films. However, the examples are not intended to be limiting, as other ClO₂ sources, other thermoplastic polymers, other polyolefin polymers, other waxes and other materials suitable to control the rates of moisture vapor transmission and the release rate of the biocides can be employed. The methods are exemplary only and other methods for preparing the biocide compositions of the invention can be determined by those skilled in the art without departing from the scope of the invention herein disclosed and claimed.

### Example 1

To 100 grams of polycaprolactone (TONE P767) were added amounts of a commercial ClO₂ source (Perlox™) to result in Perlox™ concentrations of 10%, 20%, 30% and 40% by weight. The ingredients were mixed manually and heated in a forced air oven to 60° C. The mixture was then transferred to an industrial Waring high intensity mixer and mixed at low speed for one minute and at high speed for two minutes. The Perlox™, based on an expanded amorphous aluminum silicate, has an extremely low packing density and absorbed the melting polymer quite rapidly, thus increasing the combination's packing density substantially and creating a free-flowing non-dusting powder.

### Example 2

Five grams of the 10% Perlox™—containing powder from Example 1 were placed into a 2 liter cylindrical polyvinylchloride container together with a moist cotton ball. The container was closed with a screw lid. After standing for 2 hours at room temperature, the container was opened and a strong chlorine dioxide odor was noticed.

### Example 3

Five grams of the 10% Perlox™—containing powder from Example 1 were placed between platens that were heated to 75° C. and pressed at 750 psi. A transparent film of approximately four inches in diameter and approximately seven mils thick was formed. As described in Example 2, the film was placed in a 2 liter cylinder along with a moist cotton ball. After 24 hours a strong odor of chlorine dioxide was noticed upon opening of the container.

### Example 4

To 5 grams of the 10% Perlox™—containing powder from Example 1 were added 3 grams of Polywax 500, a low molecular weight polyethylene having a low melting point (Baker Petrolite Polymers Division of Baker Hughes). This mixture was heated to 60° C. and then mixed for one minute at low speed and two minutes at high speed in the Waring blender. The addition of the polyethylene wax lowered the moisture vapor transmission of the polymer composition and thus served as a means to control the ingress of moisture and consequently the release rate of chlorine dioxide.

### Example 5

To 3 grams of the 40% Perlox™—containing powder from Example 1 were added 6 grams of Microthene F (high molecular weight high density polyethylene). After intensive mixing of the powder blend for one minute each at low and high speed in a Waring blender, an aliquot of 2 grams of the mixture was placed between heated platens of a Burton Press at 260° F. for 5 minutes and at a pressure of 150 psi. A transparent flexible film, measuring 4×4 inches at a thickness of 5 mils was obtained. The low moisture permeability of the polyethylene caused extremely slow release of ClO₂ when the film of this example was exposed to moisture.

### Example 6

To lower the cost of the invention composition, a low molecular weight polyethylene with a low melting point can be substituted for the polycaprolactone, although this also slows the release of biocide from the final product. For example, a 40% concentration by weight of Perlox™ was obtained by combining 4 parts of Perlox™ with 6 parts of Polywax 500. The ingredients were mixed manually and heated in a forced air oven to 60° C. They were then transferred to an industrial Waring high intensity mixer and mixed at low speed for one minute and at high speed for two minutes.

### Example 7

The biocide release rate was slowed even further by combining 3 parts of the material from Example 6 with 6 parts of Microthene F polyethylene.

### Example 8

To 23.25 grams of Perlox™ were added 5.85 g of polycaprolactone (P767 TONE). The ingredients were mixed in a one liter Waring blender for one minute at low speed and 2 minutes at high speed. The resulting powder was heated at 70° C. for 3 hours to attain a homogenous blend.

The original Perlox™ had a bulk density of 0.093 grams/cc. After mixing with the polycaprolactone, the bulk density of the mixture was increased to 0.44 grams/cc.

While the invention has been described herein with reference to the preferred embodiments, it is to be understood that it is not intended to limit the invention to the specific forms disclosed. On the contrary, it is intended that the invention cover all modifications and alternative forms falling within the scope of the appended claims.

We claim:

1. A biocidal composition, comprising a mixture of
(a) a substantially oxidation-resistant first thermoplastic polymer having a melting point of less than about 100° C.; and
(b) a composition for releasing chlorine dioxide gas upon exposure to moisture and having a bulk density less than about 0.15 g/cc,
wherein the mixture of the first thermoplastic polymer (a) and the composition (b) has a higher bulk density than composition (b) and is a substantially free-flowing non-dusting powder.

2. The biocidal composition of claim 1, wherein the composition for releasing chlorine dioxide gas comprises an acidified expanded amorphous aluminum silicate impregnated with a chlorite salt.

3. The biocidal composition of claim 1, wherein the composition for releasing chlorine dioxide gas has a bulk density of about 0.03 g/cc to about 0.15 g/cc.

4. The biocidal composition of claim 1, wherein the first thermoplastic polymer has a moisture vapor transmission capability of about 100 to about 1000 grams per 24 hours per square meter per mil of thickness.

5. The biocidal composition of claim 1, wherein the first thermoplastic polymer is selected from the group consisting of a polycaprolactone, a low molecular weight polyethylene, and mixtures thereof.

6. A manufactured article comprising the biocidal composition of claim 1.

7. The manufactured article of claim 6, wherein the article comprises an extruded article, an injection molded article, a blow molded article, a film, a sheet, and combinations thereof.

8. The manufactured article of claim 7, wherein the article comprises a film.

9. The manufactured article of claim 8, wherein the article comprises a woven or non-woven fabric comprising said film adhered thereto.

10. A polymeric matrix comprising:
(a) a biocidal composition that comprises a mixture of
(i) a substantially oxidation-resistant first thermoplastic polymer having a melting point of less than about 100° C.; and
(ii) a composition for releasing chlorine dioxide gas upon exposure to moisture, having a bulk density less than about 0.15 g/cc, wherein the mixture of the first thermoplastic polymer (i) and the composition (ii) has a higher bulk density than composition (ii) and is a substantially free-flowing non-dusting powder; and
(b) a second thermoplastic polymer containing the biocidal composition embedded therein.

11. The polymeric matrix of claim 10, wherein the first thermoplastic polymer has a moisture vapor transmission capability of about 100 to about 1000 grams per 24 hours per square meter per mil of thickness.

12. The polymeric matrix of claim 10, wherein the second thermoplastic polymer has a lower vapor transmission capability than that of the first thermoplastic polymer.

13. The polymeric matrix of claim 10, wherein the second thermoplastic polymer has a moisture vapor transmission capability of about 10 to about 1000 grams per 24 hours per square meter per mil of thickness.

14. The polymeric matrix of claim 10, wherein the composition for releasing chlorine dioxide gas comprises an acidified expanded amorphous aluminum silicate impregnated with a chlorite salt.

15. The polymeric matrix of claim 10, wherein the second thermoplastic polymer comprises a polyolefin.

16. A manufactured article comprising the polymeric matrix of claim 10.

17. The manufactured article of claim 16, wherein the article comprises an extruded article, an injection molded article, a blow molded article, a film, a sheet, and combinations thereof.

18. The manufactured article of claim 16, wherein the article releases chlorine dioxide gas upon exposure to moisture.

19. The article of claim 16, wherein the article comprises a film.

20. The article of claim 19, wherein the article comprises a woven or non-woven fabric comprising said film adhered thereto.
